(19) United States
(12) Patent Application Publication
(10) Pub. No.: US 2025/0049132 A1
(43) Pub. Date: Feb. 13, 2025

(54) EXTRACTOR AND AEROSOL-GENERATING DEVICE INCLUDING THE SAME

(71) Applicant: KT&G CORPORATION, Daejeon (KR)

(72) Inventors: Jongsub LEE, Sungnam-si, Gyeonggi-do (KR); Sangkyu PARK, Seoul (KR); Hwikyeong AN, Seoul (KR); Jaemin LEE, Siheung-si, Gyeonggi-do (KR); Byungsung CHO, Gwangmyung-si, Gyeonggi-do (KR); Daenam HAN, Seoul (KR)

(73) Assignee: KT&G CORPORATION, Daejeon (KR)

(21) Appl. No.: 18/721,478

(22) PCT Filed: Dec. 23, 2022
(86) PCT No.: PCT/KR2022/021190

§ 371 Date: Jun. 18, 2024

(30) Foreign Application Priority Data
Dec. 28, 2021 (KR) 10-2021-0190269
Jul. 20, 2022 (KR) 10-2022-0089741

(51) Int. Cl. A24F 40/465; A24F 40/48; A24F 40/85; H05B 6/10

(52) U.S. Cl. CPC A24F 40/465; A24F 40/48; A24F 40/85; H05B 6/108

(57) ABSTRACT

An extractor and an aerosol-generating device including the same are disclosed. The extractor of the disclosure includes a first extractor shaped to define a first cavity and having an open upper side; a heater protruding upwards from a bottom of the first extractor; and a second extractor shaped to define a second cavity having an open upper side, the second extractor including a bottom that is shaped to define a through-hole that is sized to permit the heater to pass therethrough, wherein the second extractor is inserted into the first cavity and is movably coupled to the first extractor upwards and downwards.

### TECHNICAL FIELD

The present disclosure relates to an extractor and an aerosol-generating device including the same.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE

### Technical Problem

It is an object of the present disclosure to solve the above and other problems.

It is another object of the present disclosure to facilitate cleaning of an extractor and an aerosol-generating device including the same.

It is still another object of the present disclosure to facilitate removal of foreign substances from a heater.

It is still another object of the present disclosure to provide an extractor having a novel structure, in which a flow path through which air flows to a stick is formed.

It is still another object of the present disclosure to prevent introduction of external foreign substances and to facilitate separation of an extractor from a body.

### Technical Solution

In accordance with an aspect of the present disclosure for accomplishing the above and other objects, there is provided an extractor comprising: a first extractor shaped to define a first cavity and having an open upper side; a heater protruding upwards from a bottom of the first extractor; and a second extractor shaped to define a second cavity having an open upper side, the second extractor including a bottom that is shaped to define a through-hole that is sized to permit the heater to pass therethrough, wherein the second extractor is inserted into the first cavity and is movably coupled to the first extractor upwards and downwards.

In accordance with another aspect of the present disclosure, there is provided an aerosol-generating device including a body shaped to define an insertion space that is sized to receive the first extractor and the second extractor; and an induction coil disposed to surround a portion of the insertion space, the induction coil being configured to cause the heater to generate heat.

### Advantageous Effects

According to at least one of embodiments of the present disclosure, it may be possible to facilitate cleaning of an extractor and an aerosol-generating device including the same.

According to at least one of embodiments of the present disclosure, it may be possible to facilitate removal of foreign substances from a heater.

According to at least one of embodiments of the present disclosure, it may be possible to provide an extractor having a novel structure, in which a flow path through which air flows to a stick is formed.

According to at least one of embodiments of the present disclosure, it may be possible to prevent introduction of external foreign substances and to facilitate separation of an extractor from a body.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### DESCRIPTION OF DRAWINGS

FIGS. 1 to 14 are views showing examples of an aerosol-generating device according to embodiments of the present disclosure.

### MODE FOR INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

With respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

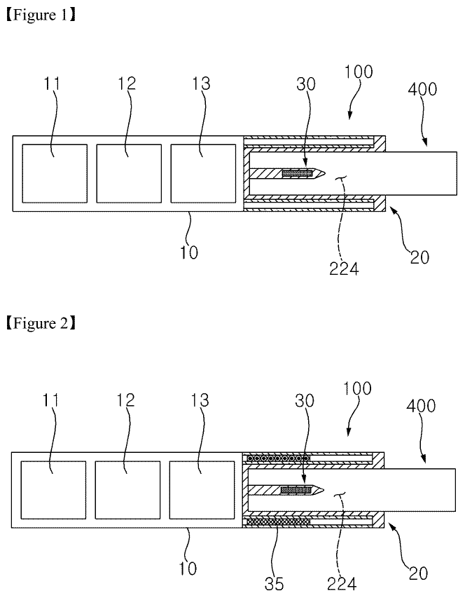

Referring to FIGS. 1 and 2, the aerosol-generating device 100 may include at least one of a battery 11, a controller 12, or a sensor 13. At least one of the battery 11, the controller 12, or the sensor 13 may be disposed in a body 10 of the aerosol-generating device 100.

An extractor 20 may be inserted into an insertion space defined in the body 10. A stick 400 may be inserted into a cavity 224 in the extractor 20.

A heater 30 may be located in the extractor 20. The heater 30 may protrude from the bottom of the extractor 20 and may extend upwards. The heater 30 may be a resistive heater. The heater 30 may heat the interior of the extractor 20 and/or the stick 400 inserted into the extractor 20.

When the stick 400 is inserted into the extractor 20, one end of the stick 400 may be exposed to the outside of the extractor 20 and the body 10. When the stick 400 is inserted into the cavity 224 in the extractor 20, the heater 30 may penetrate an end of the stick 400 to be inserted into the stick 400. The stick 400 may be heated by the heater 30. A user may hold an end of the stick 400, which is exposed to the outside, in the mouth to inhale air.

The battery 11 may supply power to operate components of the aerosol-generating device 100. The battery 11 may supply power to at least one of the controller 12, the sensor 13, an induction coil 35, or the heater 30. The battery 11 may supply power required for operating a display, a motor, etc. mounted in the aerosol-generating device 100.

The controller 12 may control the overall operation of the aerosol-generating device 100. The controller 12 may control the operation of at least one of the battery 11, the induction coil 35, or the sensor 13. The controller 12 may control the operation of the display, the motor, etc. mounted in the aerosol-generating device 100. The controller 12 may check the state of each of the components of the aerosol-generating device 100 to determine whether the aerosol-generating device 100 is in an operable state.

The sensor 13 may detect the temperature of the heater 30. The controller 12 may control the temperature of the heater 30 based on the temperature of the heater 30 detected by the sensor 13. The controller 12 may transmit information about the temperature of the heater 30 detected by the sensor 13 to the user through a user interface.

Referring to FIG. 1, the heater 30 may be electrically connected to the battery 11. The heater 30 may generate heat upon directly receiving current from the battery 11 without the necessity of an induction coil 35 (refer to FIG. 2).

Referring to FIG. 2, the aerosol-generating device 100 may include an induction coil 35. When the extractor 20 is inserted into the body 10, the induction coil 35 may surround the extractor 20 and the heater 30. The induction coil 35 may cause the heater 30 to generate heat. The heater 30 may be a susceptor. The heater 30 may generate heat due to a magnetic field generated by alternating current flowing through the induction coil 35. The magnetic field may pass through the heater 30 to generate an eddy current in the heater 30. The current may cause the heater 30 to generate heat.

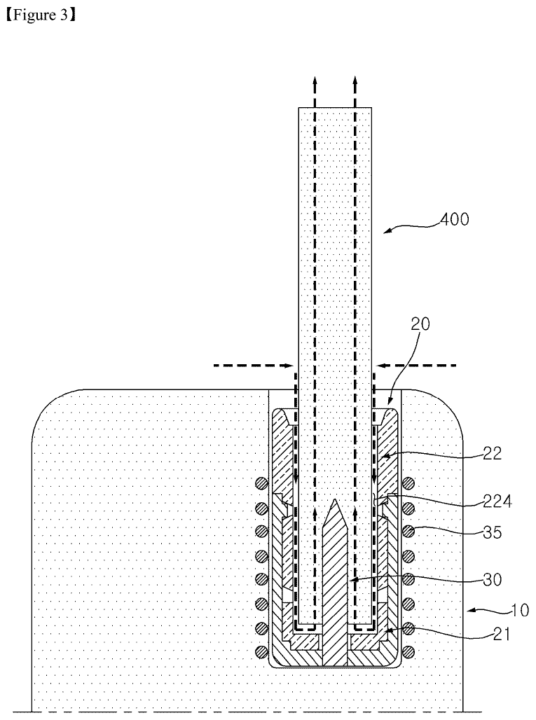

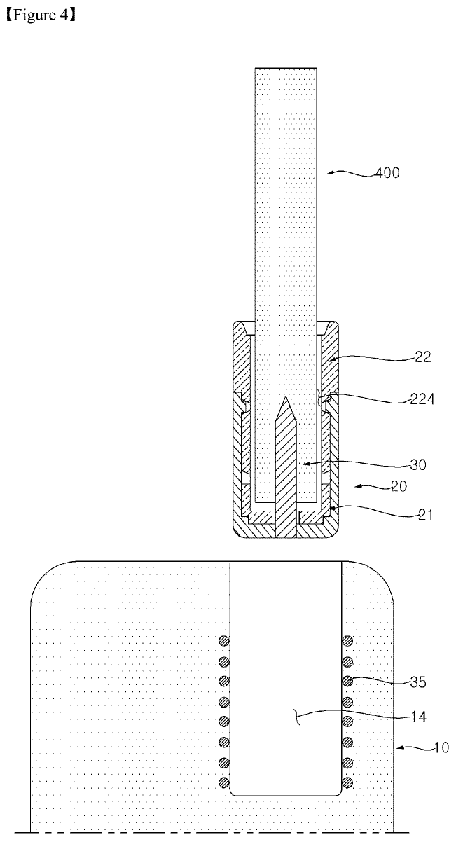

Referring to FIGS. 3 and 4, the body 10 may have an insertion space 14 defined therein. The insertion space 14 may be open upwards. The induction coil 35 may be wound around the insertion space 14. The extractor 20 may be removably inserted into the insertion space 14 through the opening in the insertion space 14. The insertion space 14 and the extractor 20 may have cylindrical shapes corresponding to each other. The extractor 20 may include a cylindrical interior. One end portion of the stick 400 may be inserted into the extractor 20, and the other end portion thereof may be exposed to the outside of the extractor 20 and the body 10.

The extractor 20 may include a first extractor 21 and a second extractor 22. The second extractor 22 may be accommodated in the first extractor 21. The second extractor 22 may be coupled to the first extractor 21. The second extractor 22 may have defined therein a cavity 224, which has an open upper side. The stick 400 may be inserted into the cavity 224 in the second extractor 22.

The heater 30 may be secured to the bottom 211 of the first extractor 21. The heater 30 may protrude from the bottom 211 of the first extractor 21 so as to be elongated upwards. The heater 30 may have a cylindrical body. The heater 30 may have a pointed upper end. The upper end of the heater 30 may be inserted into the stick 400 inserted into the cavity 224 in the second extractor 22. The induction coil 35 surrounding the insertion space 14 may cause the heater 30 to generate heat. Accordingly, the heater 30 may heat the stick 400 to generate an aerosol.

In another example, the heater 30 may directly receive power from a power source to generate heat without the necessity of the induction coil 35. In this case, the heater 30 may be in contact with a terminal formed on the bottom of the insertion space 14 via a terminal formed under the bottom 211 of the first extractor 21, and thus may be electrically connected to the power source.

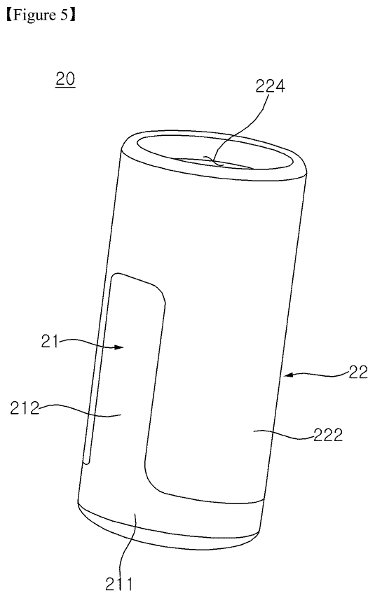

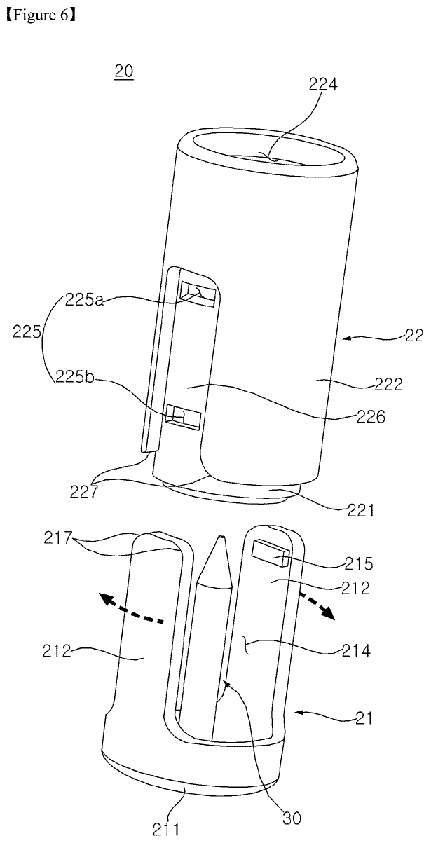

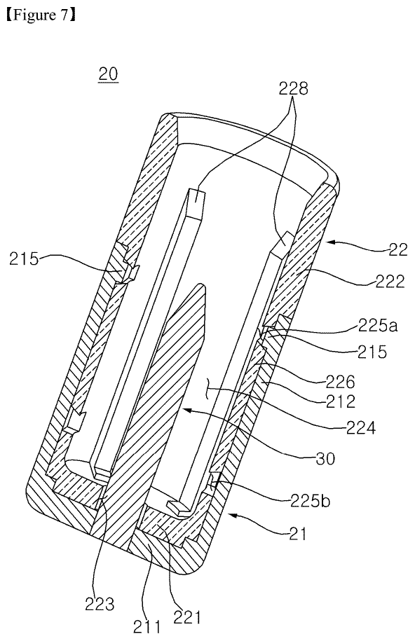

Referring to FIGS. 5 and 6, the extractor 20 may include a first extractor 21 and a second extractor 22. The second extractor 22 may be coupled to the interior of the first extractor 21. The extractor 20, which is formed by coupling between the first extractor 21 and the second extractor 22, may have a cylindrical shape. The second extractor 22 may be coupled to the first extractor 21 so as to be movable upwards.

The first extractor 21 may have defined therein a first cavity 214, which is open upwards. The first cavity 214 may be defined by the bottom 211 and the side wall 212 of the first extractor 21. The bottom 211 of the first extractor 21 may have a disc shape or a bowl shape. The heater 30 may protrude upwards from the bottom 211 of the first extractor 21. The side wall 212 of the first extractor 21 may extend upwards from the circumference of the bottom 211 of the first extractor 21. The side wall 212 of the first extractor 21 may be formed in a pair, and the pair of side walls 212 of the first extractor 21 may be located opposite each other with respect to the first cavity 214. The pair of side walls 212 of the first extractor 21 may extend long. In another example, the side wall 212 of the first extractor 21 may extend in the circumferential direction so as to surround the first cavity 214. Alternatively, a plurality of side walls 212 of the first extractor 21 may be arranged in the circumferential direction. The side wall 212 of the first extractor 21 may be referred to as a first side wall 212.

The second extractor 22 may be formed in a cylindrical shape. The second extractor 22 may have defined therein a second cavity 224, which is open upwards. The second cavity 224 may have a cylindrical shape. The second cavity 224 in the second extractor 22 may be defined by the bottom 221 and the side wall 222 of the second extractor 22. The bottom 221 of the extractor 22 may have a disc shape or a bowl shape. The side wall 222 of the second extractor 22 may extend upwards from the bottom 221 of the second extractor 22. The side wall 222 of the second extractor 22 may extend in the circumferential direction so as to surround the second cavity 224. The side wall 222 of the second extractor 22 may be referred to as a second side wall 222.

A portion of the second extractor 22 may be inserted into the first cavity 214 in the first extractor 21. The bottom 211 of the first extractor 21 may face the bottom 221 of the second extractor 22. The side wall 212 of the first extractor 21 may cover a portion of the side wall 222 of the second extractor 22.

A first coupling portion 215 may be detachably coupled to a second coupling portion 225a and a third coupling portion 225b. The first coupling portion 215 may be formed on any one of the side wall 212 of the first extractor 21 and the side wall 222 of the second extractor 22. The second coupling portion 225a and the third coupling portion 225b may be formed on the other of the side wall 212 of the first extractor 21 and the side wall 222 of the second extractor 22.

In an example, the first coupling portion 215 may protrude inwards from the side wall 212 of the first extractor 21 toward the first cavity 214, and the second coupling portion 225a and the third coupling portion 225b may be formed so as to be depressed in the side wall 222 of the second extractor 22. In another example, the first coupling portion 215 may protrude outwards from the side wall 222 of the second extractor 22, and the second coupling portion 225a and the third coupling portion 225b may be formed so as to be depressed in the side wall 212 of the first extractor 21. The first coupling portion 215 may be detachably inserted into each of the second coupling portion 225a and the third coupling portion 225b. The first coupling portion 215 may be referred to as a coupling protrusion 215. The second coupling portion 225a may be referred to as a first coupling hole 225a. The third coupling portion 225b may be referred to as a second coupling hole 225b.

In another example, the first coupling portion 215 may be a magnet disposed on the side wall 212 of the first extractor 21. The second coupling portion 225a may be a magnet disposed on the side wall 222 of the second extractor 22 to generate attractive force with the first coupling portion 215. The third coupling portion 225b may be a magnet disposed on the side wall 222 of the second extractor 22 to generate attractive force with the first coupling portion 215. In another example, the first coupling portion 215 may be a magnet disposed on the side wall 222 of the second extractor 22, and the second coupling portion 225a and the third coupling portion 225b may be magnets disposed on the side wall 212 of the first extractor 21. The first coupling portion 215 may be detachably coupled to each of the second coupling portion 225a and the third coupling portion 225b using attractive force generated therebetween. The first coupling portion 215 may be referred to as a first magnet 215. The second coupling portion 225a may be referred to as a second magnet 225a. The third coupling portion 225b may be referred to as a third magnet 225b.

The first coupling portion 215 may be formed in a pair, and the pair of first coupling portions 215 may be located opposite each other. The second coupling portion 225a may be formed in a pair, and the pair of second coupling portions 225a may be located opposite each other. The third coupling portion 225b may be formed in a pair, and the pair of third coupling portions 225b may be located opposite each other. The third coupling portion 225b may be formed below the second coupling portion 225a. However, the present disclosure is not limited thereto. At least one coupling portion may be further formed below the third coupling portion 225b.

The side wall 212 of the first extractor 21 may be formed in a pair, and the pair of side walls 212 of the first extractor 21 may be located opposite each other with respect to the first cavity 214. The pair of side walls 212 of the first extractor 21 may extend parallel to each other. Each of the pair of first coupling portions 215 may be formed on a respective one of the pair of side walls 212 of the first extractor 21. The pair of side walls 212 of the first extractor 21 may be formed to be pivotable inwards and outwards about the bottom 211 of the first extractor 21. Each of the pair of first coupling portions 215 may protrude inwards from the upper portion of a respective one of the pair of side walls 212 of the first extractor 21.

A recessed portion 226 may be formed in such a manner that the outer surface of the side wall 222 of the second extractor 22 is recessed inwards. The recessed portion 226 may have a shape corresponding to the side wall 212 of the first extractor 21. The recessed portion 226 may be elongated in the upward-downward direction. The recessed portion 226 may be formed in a pair, and the pair of recessed portions 226 may be located opposite each other with respect to the second cavity 224. Each of the pair of recessed portions 226 may be formed at a position corresponding to a respective one of the pair of side walls 212 of the first extractor 21. The recessed portion 226 may have an open lower side. The recessed portion 226 may have a closed upper side. The side wall 212 of the first extractor 21 may be inserted into a groove formed by the recessed portion 226 to cover the recessed portion 226. The side wall 212 of the first extractor 21 may slide upwards and downwards in the recessed portion 226. The recessed portion 226 may guide upward-downward sliding movement of the side wall 212 of the first extractor 21. The first coupling portion 215 may be formed in the recessed portion 226. Alternatively, the second coupling portion 225a and the third coupling portion 225b may be formed in the recessed portion 226.

First guide portions 217 may be formed on the corners of the upper end of the side wall 212 of the first extractor 21. The first guide portions 217 may be formed curvedly on the corners of the side wall 212 of the first extractor 21. Second guide portions 227 may be formed curvedly on the corners of the open side of the recessed portion 226. The side wall 212 of the first extractor 21 may be guided so as to be inserted into the recessed portion 226 by contact between the first guide portions 217 and the second guide portions 227.

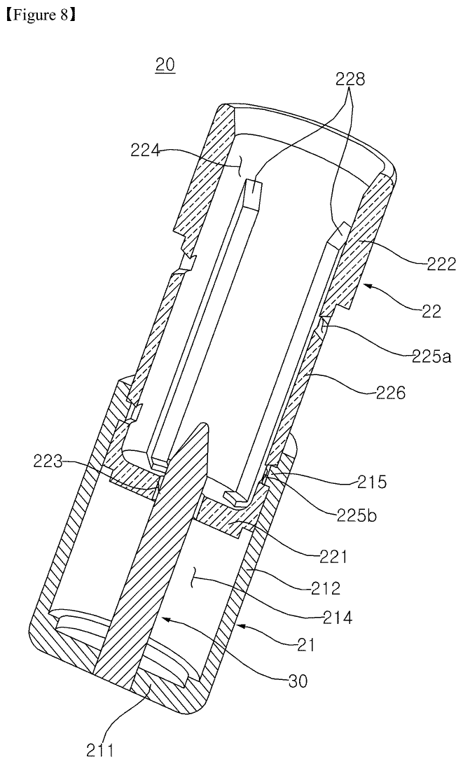

Referring to FIGS. 7 to 9, a through-hole 223 may be formed through the bottom 221 of the second extractor 22. The through-hole 223 may be formed corresponding to the heater 30. The heater 30 may pass through the through-hole 223. The heater 30 may protrude to the interior of the second cavity 224 through the through-hole 223. Each of the through-hole 223 and the heater 30 may have a circular cross-section. The diameter of the through-hole 223 may be larger than the diameter of the heater 30. When the heater 30 is inserted into the through-hole 223, a gap may be formed between the inner circumferential surface of the bottom 221 of the second extractor 22, which defines the through-hole 223, and the outer circumferential surface of the heater 30.

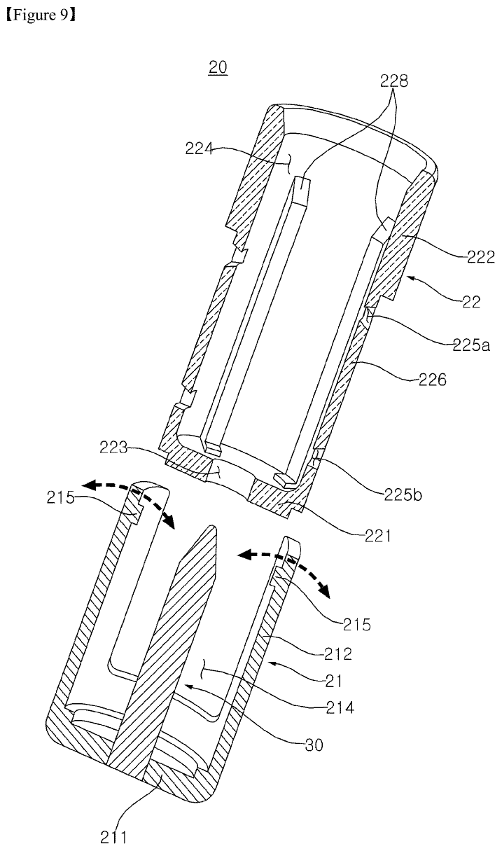

The second extractor 22 may be coupled to the first extractor 21 so as to be movable upwards and downwards. The second extractor 22 may be located at a first position, which corresponds to the lowermost position of the second extractor 22 relative to the first extractor 21 (refer to FIG. 7). The second extractor 22 may be located at a second position, which corresponds to the uppermost position of the second extractor 22 relative to the first extractor 21 (refer to FIG. 8). The second extractor 22 may move relative to the first extractor 21 from the first position to the second position or from the second position to the first position.

The second extractor 22 may be stationary at the first and second positions. The second extractor 22 may move between the first position and the second position. When the second extractor 22 is located at the first position, the bottom 211 of the first extractor 21 and the bottom 221 of the second extractor 22 may be adjacent to or in contact with each other. When the second extractor 22 is located at the second position, the bottom 211 of the first extractor 21 and the bottom 221 of the second extractor 22 may be located relatively far away from each other.

In an example, the first coupling portion 215 may be formed on the first side wall 212, and the second coupling portion 225a and the third coupling portion 225b may be formed on the second side wall 222. When the second extractor 22 is located at the first position, the first coupling portion 215 may be coupled to the second coupling portion 225a, whereby the second extractor 22 may be secured to the first extractor 21. When the second extractor 22 is pulled upwards away from the first extractor 21 with a predetermined amount of force, the first coupling portion 215 coupled to the second coupling portion 225a may be separated from the second coupling portion 225a. When the first coupling portion 215 is separated from the second coupling portion 225a, the second extractor 22 may be released and become movable upwards relative to the first extractor 21. The second extractor 22 may move from the first position to the second position. When the second extractor 22 reaches the second position, the first coupling portion 215 may be coupled to the third coupling portion 225b, and thus the second extractor 22 may be secured to the first extractor 21. When the second extractor 22 located at the second position is pushed downwards toward the first extractor 21, the first coupling portion 215 may be separated from the third coupling portion 225b, and the second extractor 22 may move toward the first position. When the second extractor 22 reaches the first position, the first coupling portion 215 may be coupled to the second coupling portion 225a, and thus the second extractor 22 may be secured to the first extractor 21.

The first coupling portion 215 may be formed at a height corresponding to the upper portion of the heater 30. The third coupling portion 225b may be formed adjacent to the bottom 221 of the second extractor 22. When the second extractor 22 is located at the second position, at which the first coupling portion 215 is coupled to the third coupling portion 225b, the bottom 221 of the second extractor 22 may be located at a position corresponding to the upper portion of the heater 30 that passes through the through-hole 223.

Foreign substances generated from the stick 400 or the like may adhere to and harden on the bottom 221 of the second extractor 22 and the outer surface of the heater 30. By virtue of the above-described structure, it may be possible to easily remove the foreign substances from the bottom 221 of the second extractor 22 and the outer surface of the heater 30. In addition, it may be possible to facilitate cleaning of the interior of the extractor 20.

The coupling force between the first coupling portion 215 and the third coupling portion 225b may be greater than the coupling force between the first coupling portion 215 and the second coupling portion 225a. Accordingly, the first coupling portion 215 and the third coupling portion 225b may not be separated from each other with the force of pulling the second extractor 22 upwards away from the first extractor 21 in order to separate the first coupling portion 215 and the second coupling portion 225a from each other.

The second extractor 22 located at the second position (refer to FIG. 8) may be separated upwards from the first extractor 21 (refer to FIG. 9). When the second extractor 22 is located at the second position, the pair of side walls 212 of the first extractor 21 may be pivoted away from each other so that the first coupling portion 215 can be separated from the third coupling portion 225b. Accordingly, the second extractor 22 may become separable upwards from the first extractor 21. The second extractor 22 may be separated from the first cavity 214. The heater 30 may be separated from the through-hole 223.

Accordingly, each of the first extractor 21 and the second extractor 22 may be easily cleaned.

Meanwhile, the extractor 20 may include a first support 228. The first support 228 may protrude from the inner circumferential surface of the side wall 222 of the second extractor 22 toward the second cavity 224. The first support 228 may be provided in plural, and the plurality of first supports 228 may be arranged in the circumferential direction. The upper end of each of the first supports 228 may be inclined downwards. The lower end of each of the first supports 228 may protrude upwards from the bottom 221 of the second extractor 22.

Accordingly, the plurality of first supports 228 may support the outer circumferential surface and the bottom of the stick 400 inserted into the second cavity 224, and may form a gap between the stick 400 and the second extractor 22 to allow air to flow therethrough. Accordingly, when the user holds the stick 400 in the mouth and inhales air, the air may be introduced into the lower portion of the stick 400 through the gap between the outer circumferential surface of the stick 400 and the inner circumferential surface of the side wall 222 of the second extractor 22, and may then be delivered to the user through the stick 400 (refer to FIG. 3).

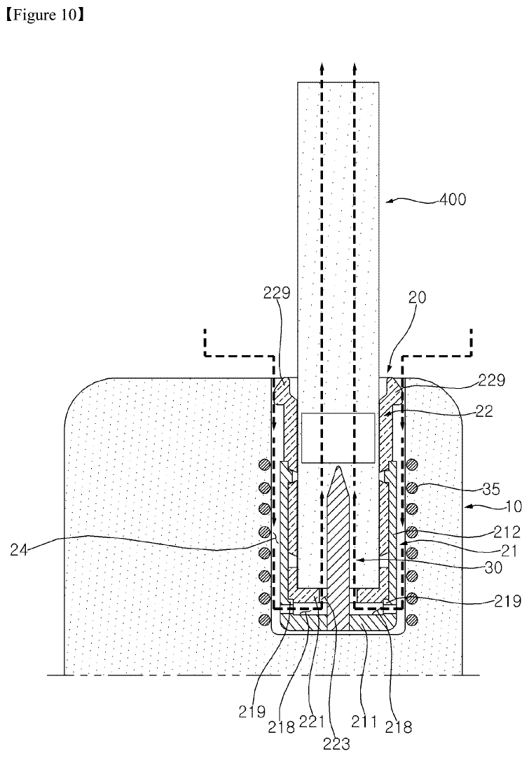

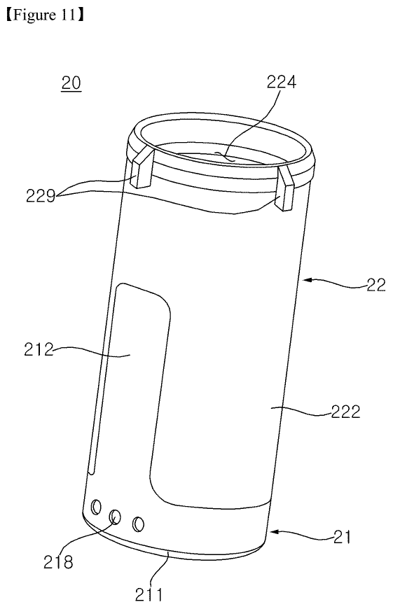

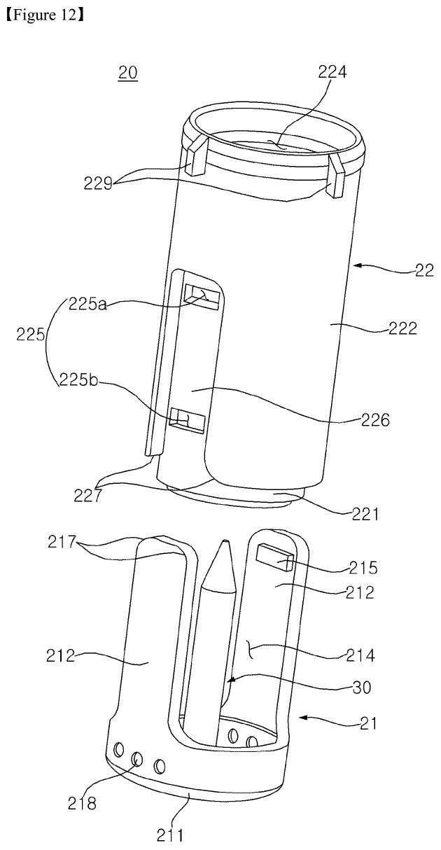

Referring to FIGS. 10 to 13, a second support 229 may protrude outwards from the outer circumferential surface of the extractor 20. The second support 229 may protrude outwards from the outer circumferential surface of the first extractor 21 or the outer circumferential surface of the second extractor 22. The second support 229 may be formed on the upper end of the second extractor 22. The second support 229 may be provided in plural, and the plurality of second supports 229 may be arranged so as to be spaced apart from each other in the circumferential direction. Accordingly, when the extractor 20 is inserted into the insertion space 24 in the body 10, the extractor 20 may be supported by the second supports 229. The second supports 229 may form a gap between the outer circumferential surface of the extractor 20 and the side wall defining the outer circumferential surface of the insertion space 24 to allow air to flow therethrough.

An inlet hole 218 may be formed in the outer circumferential surface of the bottom 211 of the first extractor 21 so as to communicate with the cavity 214 in the first extractor 21. The inlet hole 218 may be open in the lateral direction. The inlet hole 218 may be formed in plural. The plurality of inlet holes 218 may be arranged in the circumferential direction.

When the second extractor 22 is located at the first position, the bottom 221 of the second extractor 22 may be spaced upwards apart from the bottom 211 of the first extractor 21 and/or the inlet holes 218. A stopper 219 may support the bottom 221 of the second extractor 22. The stopper 219 may be formed at a position higher than the inlet holes 218. The stopper 219 may protrude from the side wall 212 of the first extractor 21 at a position higher than the inlet holes 218. Accordingly, a passage extending from the inlet holes 218 to the through-hole 223 may be formed.

Accordingly, when the user holds the stick 400 in the mouth and inhales air, the air may be introduced into the inlet holes 218 through the gap between the outer circumferential surface of the extractor 20 and the side wall defining the insertion space 24. The air introduced into the inlet holes 218 may be introduced into the lower portion of the stick 400 through the through-hole 223, and may then be delivered to the user through the stick 400.

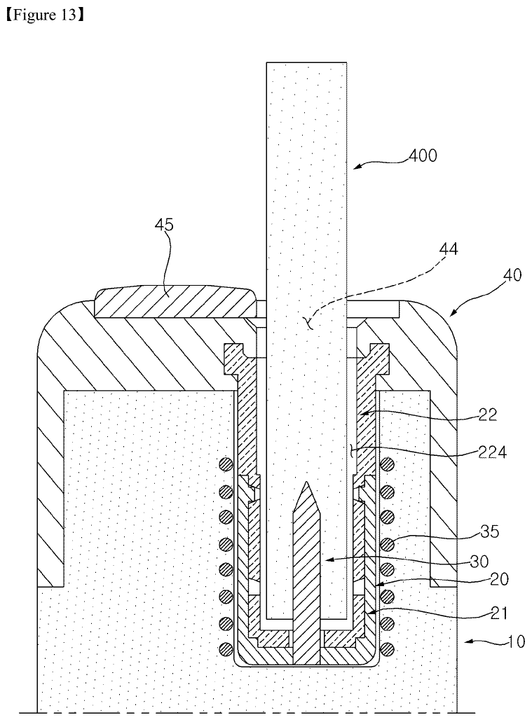

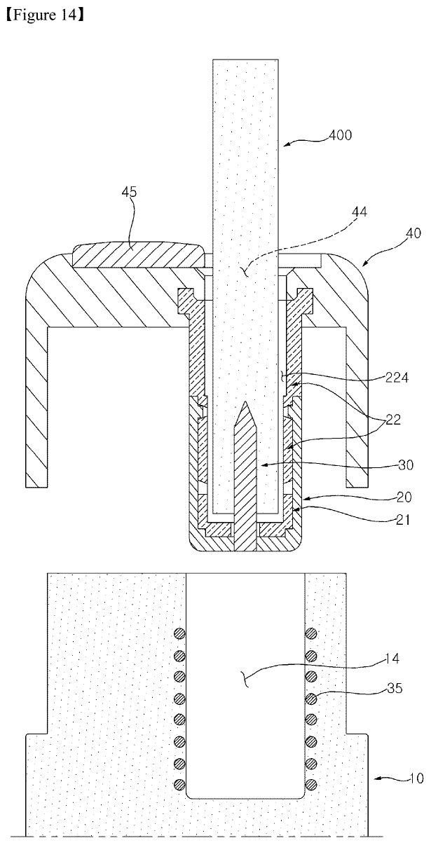

Referring to FIGS. 13 and 14, an upper case 40 may be coupled to the extractor 20. The upper case 40 may be coupled to the upper end of the second extractor 22. The extractor 20 may be detachably coupled to the upper case 40. The upper case 40 may have formed therein an insertion hole 44 communicating with the opening of the second cavity 224.

The upper case 40 may be detachably coupled to the body 10. The upper case 40 may cover the upper portion of the body 10. The upper case 40 may cover the insertion space 24 and the periphery of the insertion space 24.

The extractor 20 may protrude downwards from the upper case 40. When the upper case 40 is coupled to the body 10, the extractor 20 may be inserted into the insertion space 24. When the upper case 40 is separated from the body 10, the extractor 20 may be separated from the insertion space 24. Even in the state in which the extractor 20 is coupled to the upper case 40, the second extractor 22 may be located at the first position or the second position. In the state in which the second extractor 22 is coupled to the upper case 40, the first extractor 21 may be separated from the second extractor 22.

The upper case 40 may include a cap 45 for opening and closing the insertion hole 44. The cap 45 may be disposed on the insertion hole 44. The cap 45 may be mounted so as to be movable toward and away from a region above the insertion hole 44. When the cap 45 opens the insertion hole 44, the second cavity 224 may be opened so that the stick 400 can be inserted thereinto. The cap 45 may close the insertion hole 44 in order to prevent external foreign substances from entering the second cavity 224 and the insertion space 24.

Accordingly, one side of the body 10 may be protected from the external environment. In addition, introduction of external foreign substances into the body 10 may be prevented. In addition, the extractor 20 may be more easily separated from the body 10. In addition, foreign substances that are generated from the stick 400 or the like and adhere to and harden on the bottom 221 of the second extractor 22 and the outer surface of the heater 30 may be easily removed. In addition, each of the first extractor 21 and the second extractor 22 may be easily cleaned.

Referring to FIGS. 1 to 14, an extractor in accordance with one aspect of the present disclosure may include a first extractor shaped to define a first cavity and having an open upper side; a heater protruding upwards from a bottom of the first extractor; and a second extractor shaped to define a second cavity having an open upper side, the second extractor including a bottom that is shaped to define a through-hole that is sized to permit the heater to pass therethrough, wherein the second extractor may be inserted into the first cavity and may be movably coupled to the first extractor upwards and downwards.

In addition, in accordance with another aspect of the present disclosure, the extractor may further include a first coupling portion formed on a side wall of the first extractor; a second coupling portion formed on a side wall of the second extractor and being structured to permit detachable coupling of the first coupling portion and the second coupling portion; and a third coupling portion formed on the side wall of the second extractor at a position below the second coupling portion to permit detachable coupling of the first coupling portion and the third coupling portion.

In addition, in accordance with another aspect of the present disclosure, the first coupling portion may protrude from an inner side of the side wall of the first extractor, and wherein the second coupling portion and the third coupling portion may be respectively formed as a depression or an opening in the side wall of the second extractor.

In addition, in accordance with another aspect of the present disclosure, each of the first coupling portion, the second coupling portion, and the third coupling portion includes a respective magnet, and wherein the magnet of the first coupling portion may generate an attractive force with the respective magnets of the second coupling portion and the third coupling portion.

In addition, in accordance with another aspect of the present disclosure, when the second extractor is pulled upwards away from the first extractor in a coupled state of the first coupling portion and the second coupling portion, the first coupling portion may be separated from the second coupling portion, and the second extractor may be moved upwards relative to the first extractor until the first coupling portion couples to the third coupling portion. When the second extractor is pushed downwards toward the first extractor in a coupled state of the first coupling portion and the third coupling portion, the first coupling portion may be separated from the third coupling portion, and the second extractor may be moved downwards relative to the first extractor until the first coupling portion is coupled to the second coupling portion.

In addition, in accordance with another aspect of the present disclosure, the first coupling portion may be coupled to the third coupling portion with a coupling force greater than a coupling force between the first coupling portion and the second coupling portion.

In addition, in accordance with another aspect of the present disclosure, the side wall of the first extractor may include a pair of side walls extending upwards from the bottom of the first extractor and be located opposite each other with respect to the first cavity. The first coupling portion may include a pair of first coupling portions, and each of the pair of first coupling portions may be formed on a respective one of the pair of side walls of the first extractor. The second coupling portion may include a pair of second coupling portions, and the pair of second coupling portions may be formed on opposite locations of the side wall of the second extractor that respectively correspond to the pair of first coupling portions.

In addition, in accordance with another aspect of the present disclosure, the third coupling portion may include a pair of third coupling portions, and the pair of third coupling portions may be formed on opposite locations of the side wall of the second extractor at positions below the pair of second coupling portions and respectively correspond to the pair of first coupling portions.

In addition, in accordance with another aspect of the present disclosure, the pair of side walls of the first extractor may be formed to be pivotable outwards away from each other. When the pair of side walls of the first extractor are pivoted outwards in a coupled state of the pair of first coupling portions and the pair of third coupling portions, the pair of first coupling portions may be positionable upwards relative to the first extractor to permit relative separation of the first extractor and the second extractor.

In addition, in accordance with another aspect of the present disclosure, an outer surface of the side wall of the second extractor may be shaped to define a recessed portion that is recessed inwards and may be open downwards to facilitate relative upward-downward sliding movement between the first extractor and the second extractor, wherein the second coupling portion and the third coupling portion are formed in the recessed portion, and wherein the side wall of the first extractor may be sized to be inserted into the recessed portion to cover the recessed portion.

In addition, in accordance with another aspect of the present disclosure, the extractor may further include a first coupling portion formed on a side wall of the second extractor; a second coupling portion formed on a side wall of the first extractor and being structured to permit detachable coupling of the first coupling portion and the second coupling portion; and a third coupling portion formed on the side wall of the first extractor at a position below the second coupling portion to permit detachable coupling of the first coupling portion and the third coupling portion.

In addition, in accordance with another aspect of the present disclosure, the extractor may further include a plurality of first supports protruding inwards from the inner circumferential surface of the second extractor, and the plurality of first supports may be arranged in the circumferential direction.

In addition, in accordance with another aspect of the present disclosure, the extractor may further include a plurality of second supports protruding outwards from the outer circumferential surface of the second extractor or the first extractor. The plurality of second supports may be arranged in the circumferential direction. an outer circumferential surface of a bottom of the first extractor may be shaped to define an inlet hole that is communicate with the first cavity and the through-hole of the second extractor.

In addition, in accordance with another aspect of the present disclosure, the extractor may further include a stopper protruding inwards from the side wall of the first extractor at a position above the inlet hole to support the bottom of the second extractor and to form a passage allowing the inlet hole to communicate with the through-hole of the second extractor.

An aerosol-generating device in accordance with one aspect of the present disclosure may include a body shaped to define an insertion space that is sized to receive the first extractor and the second extractor and an induction coil, which is disposed to surround a portion of the insertion space and causes the heater to generate heat.

In addition, in accordance with another aspect of the present disclosure, the aerosol-generating device may further include an upper case structed to couple with the first extractor and the second extractor to cover a periphery of the insertion space of the body, wherein the upper case may comprise a cap, and wherein the upper case may be shaped to define an insertion hole in communication with an opening of the second cavity, and the cap may be configured to open and close the insertion hole.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An extractor comprising:
a first extractor shaped to define a first cavity and having an open upper side;
a heater protruding upwards from a bottom of the first extractor; and
a second extractor shaped to define a second cavity having an open upper side, the second extractor including a bottom that is shaped to define a through-hole that is sized to permit the heater to pass therethrough,
wherein the second extractor is inserted into the first cavity and is movably coupled to the first extractor upwards and downwards.

2. The extractor according to claim 1, further comprising:
a first coupling portion formed on a side wall of the first extractor;
a second coupling portion formed on a side wall of the second extractor and being structured to permit detachable coupling of the first coupling portion and the second coupling portion; and
a third coupling portion formed on the side wall of the second extractor at a position below the second coupling portion to permit detachable coupling of the first coupling portion and the third coupling portion.

3. The extractor according to claim 2, wherein the first coupling portion protrudes from an inner side of the side wall of the first extractor, and
wherein the second coupling portion and the third coupling portion are respectively formed as a depression or an opening in the side wall of the second extractor.

4. The extractor according to claim 2, wherein each of the first coupling portion, the second coupling portion, and the third coupling portion includes a respective magnet, and
wherein the magnet of the first coupling portion generates an attractive force with the respective magnets of the second coupling portion and the third coupling portion.

5. The extractor according to claim 2, wherein, when the second extractor is pulled upwards away from the first extractor in a coupled state of the first coupling portion and the second coupling portion, the first coupling portion is separated from the second coupling portion, and the second extractor is moved upwards relative to the first extractor until the first coupling portion couples to the third coupling portion, and
wherein, when the second extractor is pushed downwards toward the first extractor in a coupled state of the first coupling portion and the third coupling portion, the first coupling portion is separated from the third coupling portion, and the second extractor is moved downwards relative to the first extractor until the first coupling portion is coupled to the second coupling portion.

6. The extractor according to claim 2, wherein the first coupling portion is coupled to the third coupling portion with a coupling force greater than a coupling force between the first coupling portion and the second coupling portion.

7. The extractor according to claim 6, wherein the side wall of the first extractor comprises a pair of side walls extending upwards from the bottom of the first extractor and are located opposite each other with respect to the first cavity,
wherein the first coupling portion comprises a pair of first coupling portions, each of the pair of first coupling portions being formed on a respective one of the pair of side walls of the first extractor,
wherein the second coupling portion comprises a pair of second coupling portions, the pair of second coupling portions being formed on opposite locations of the side wall of the second extractor that respectively correspond to the pair of first coupling portions, and
wherein the third coupling portion comprises a pair of third coupling portions, the pair of third coupling portions being formed on opposite locations of the side wall of the second extractor at positions below the pair of second coupling portions and respectively correspond to the pair of first coupling portions.

8. The extractor according to claim 7, wherein the pair of side walls of the first extractor are formed to be pivotable outwards away from each other, and
wherein, when the pair of side walls of the first extractor are pivoted outwards in a coupled state of the pair of first coupling portions and the pair of third coupling portions, the pair of first coupling portions is separated from the pair of third coupling portions, and the second extractor is positionable upwards relative to the first extractor to permit relative separation of the first extractor and the second extractor.

9. The extractor according to claim 7,
wherein an outer surface of the side wall of the second extractor is shaped to define a recessed portion that is recessed inwards and is open downwards to facilitate relative upward-downward sliding movement between the first extractor and the second extractor,
wherein the second coupling portion and the third coupling portion are formed in the recessed portion, and
wherein the side wall of the first extractor is sized to be inserted into the recessed portion to cover the recessed portion.

10. The extractor according to claim 1, further comprising:
a first coupling portion formed on a side wall of the second extractor;
a second coupling portion formed on a side wall of the first extractor and being structured to permit detachable coupling of the first coupling portion and the second coupling portion; and
a third coupling portion formed on the side wall of the first extractor at a position below the second coupling portion to permit detachable coupling of the first coupling portion and the third coupling portion.

11. The extractor according to claim 1, further comprising:
a plurality of first supports protruding inwards from an inner circumferential surface of the second extractor, the plurality of first supports being arranged in a circumferential direction.

12. The extractor according to claim 1, further comprising:
a plurality of second supports protruding outwards from an outer circumferential surface of the second extractor or the first extractor, the plurality of second supports being arranged in a circumferential direction; and
wherein an outer circumferential surface of a bottom of the first extractor is shaped to define an inlet hole that is communicate with the first cavity and the through-hole of the second extractor.

13. The extractor according to claim 12, further comprising:
a stopper protruding inwards from a side wall of the first extractor at a position above the inlet hole to support the bottom of the second extractor and to form a passage allowing the inlet hole to communicate with the through-hole of the second extractor.

14. An aerosol-generating device comprising:
a first extractor shaped to define a first cavity and having an open upper side;
a heater protruding upwards from a bottom of the first extractor; and
a second extractor shaped to define a second cavity having an open upper side, the second extractor including a bottom that is shaped to define a through-hole that is sized to permit the heater to pass therethrough, wherein the first cavity of the first extractor is sized to receive the second extractor to permit detachable coupling of the first extractor and the second extractor;
a body shaped to define an insertion space that is sized to receive the first extractor and the second extractor; and
an induction coil disposed to surround a portion of the insertion space, the induction coil being configured to cause the heater to generate heat.

15. The aerosol-generating device according to claim 14, further comprising:
an upper case structed to couple with the first extractor and the second extractor to cover a periphery of the insertion space of the body,
wherein the upper case comprises a cap, and
wherein the upper case is shaped to define an insertion hole in communication with an opening of the second cavity, and the cap is configured to open and close the insertion hole.
